(19) United States
(12) Patent Application Publication
(10) Pub. No.: US 2014/0036710 A1
(43) Pub. Date: Feb. 6, 2014

(54) INTER-RAT MEASUREMENTS FOR A DUAL-SIM DUAL-ACTIVE DEVICE

(71) Applicant: QUALCOMM Incorporated, San Diego, CA (US)

(72) Inventors: Tom CHIN, San Diego, CA (US); Guangming SHI, San Diego, CA (US); Kuo-Chun LEE, San Diego, CA (US)

(73) Assignee: QUALCOMM Incorporated, San Diego, CA (US)

(21) Appl. No.: 13/959,407

(22) Filed: Aug. 5, 2013

Related U.S. Application Data
(60) Provisional application No. 61/679,993, filed on Aug. 6, 2012.

(51) Int. Cl. H04W 24/10

(52) U.S. Cl. CPC H04W 24/10
USPC 370/252

(57) ABSTRACT

A method of wireless communication is presented. The method includes monitoring a first RAT for a first paging message with a first receive chain. The method also includes monitoring a second RAT for a second paging message with a second receive chain. The method further includes performing, for the first SIM, an inter-frequency/inter-RAT measurement for the first RAT. The method still further includes performing, for the second SIM, an inter-frequency/inter-RAT measurement for the second RAT.

### CROSS REFERENCE TO RELATED APPLICATION

This application claims the benefit under 35 U.S.C. §119(e) to U.S. Provisional Patent Application No. 61/679,993 entitled “INTER-RAT MEASUREMENT FOR A DUAL-SIM DUAL-ACTIVE DEVICE,” filed on Aug. 6, 2012, the disclosure of which is expressly incorporated by reference herein in its entirety.

### BACKGROUND

1. Field

Aspects of the present disclosure relate generally to wireless communication systems, and more particularly, to performing inter-radio access technology (RAT) measurements for a dual-subscriber identity module (SIM) dual active device in a TD-SCDMA network.

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). For example, China is pursuing TD-SCDMA as the underlying air interface in the UTRAN architecture with its existing GSM infrastructure as the core network. The UMTS also supports enhanced 3G data communications protocols, such as High Speed Packet Access (HSPA), which provides higher data transfer speeds and capacity to associated UMTS networks. HSPA is a collection of two mobile telephony protocols, High Speed Downlink Packet Access (HSDPA) and High Speed Uplink Packet Access (HSUPA), which extends and improves the performance of existing wideband protocols.

As the demand for mobile broadband access continues to increase, research and development continue to advance the UMTS technologies not only to meet the growing demand for mobile broadband access, but to advance and enhance the user experience with mobile communications.

### SUMMARY

In one aspect of the present disclosure, a method of wireless communication is presented. The method includes monitoring a first RAT for a first paging message with a first receive chain. The first paging message is monitored for a first SIM. The method also includes monitoring a second RAT for a second paging message with a second receive chain. The second paging message is monitored for a second SIM. The method further includes performing, for the first SIM, an inter-frequency/inter-RAT measurement for the first RAT. The inter-frequency/inter-RAT measurement is performed with the first receive chain after monitoring for the first paging message and the second paging message. The method still further includes performing, for the second SIM, an inter-frequency/inter-RAT measurement for the second RAT. The inter-frequency/inter-RAT measurement is performed with the second receive chain after monitoring for the first paging message and the second paging message.

Another aspect of the present disclosure is directed to an apparatus including means for monitoring a first RAT for a first paging message with a first receive chain. The first paging message is monitored for a first SIM. The apparatus also includes means for monitoring a second RAT for a second paging message with a second receive chain. The second paging message is monitored for a second SIM. The apparatus further includes means for performing, for the first SIM, an inter-frequency/inter-RAT measurement for the first RAT. The inter-frequency/inter-RAT measurement is performed with the first receive chain after monitoring for the first paging message and the second paging message. The apparatus still further includes means for performing, for the second SIM, an inter-frequency/inter-RAT measurement for the second RAT. The inter-frequency/inter-RAT measurement is performed with the second receive chain after monitoring for the first paging message and the second paging message.

In another aspect of the present disclosure, a computer program product for wireless communications in a wireless network having a non-transitory computer-readable medium is disclosed. The computer readable medium has non-transitory program code recorded thereon which, when executed by the processor(s), causes the processor(s) to perform operations of monitoring a first RAT for a first paging message with a first receive chain. The first paging message is monitored for a first SIM. The program code also causes the processor(s) to monitor a second RAT for a second paging message with a second receive chain. The second paging message is monitored for a second SIM. The program code further causes the processor(s) to perform, for the first SIM, an inter-frequency/inter-RAT measurement for the first RAT. The inter-frequency/inter-RAT measurement is performed with the first receive chain after monitoring for the first paging message and the second paging message. The program code still further causes the processor(s) to perform, for the second SIM, an inter-frequency/inter-RAT measurement for the second RAT. The inter-frequency/inter-RAT measurement is performed with the second receive chain after monitoring for the first paging message and the second paging message.

Another aspect of the present disclosure is directed to wireless communication having a memory and at least one processor coupled to the memory. The processor(s) is configured to monitor a first RAT for a first paging message with a first receive chain. The first paging message is monitored for a first SIM. The processor(s) is also configured to monitor a second RAT for a second paging message with a second receive chain. The second paging message is monitored for a second SIM. The processor(s) is further configured to perform, for the first SIM, an inter-frequency/inter-RAT measurement for the first RAT. The inter-frequency/inter-RAT measurement is performed with the first receive chain after monitoring for the first paging message and the second paging message. The processor(s) is still further configured to perform, for the second SIM, an inter-frequency/inter-RAT measurement for the second RAT. The inter-frequency/inter-RAT measurement is performed with the second receive chain after monitoring for the first paging message and the second paging message.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

FIG. 1 is a block diagram conceptually illustrating an example of a telecommunications system.

FIG. 2 is a block diagram conceptually illustrating an example of a frame structure in a telecommunications system.

FIG. 3 is a block diagram conceptually illustrating an example of a node B in communication with a UE in a telecommunications system.

FIG. 4 illustrates a network coverage area according to aspects of the present disclosure.

FIGS. 5-8 illustrate timelines for monitoring paging messages and measuring inter-RAT/inter-frequency signals according to one aspect of the present disclosure.

FIG. 9 is a block diagram illustrating a method for performing inter-RAT/inter-frequency measurements according to one aspect of the present disclosure.

FIG. 10 is a diagram illustrating an example of a hardware implementation for an apparatus employing a processing system according to one aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

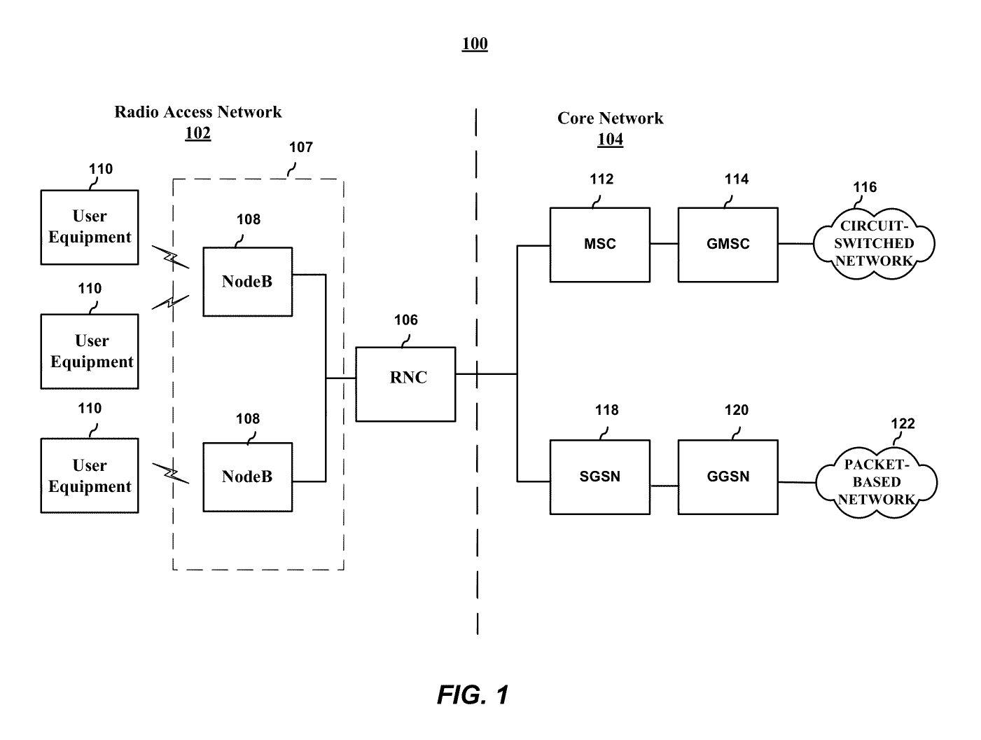

Turning now to FIG. 1, a block diagram is shown illustrating an example of a telecommunications system 100. The various concepts presented throughout this disclosure may be implemented across a broad variety of telecommunication systems, network architectures, and communication standards. By way of example and without limitation, the aspects of the present disclosure illustrated in FIG. 1 are presented with reference to a UMTS system employing a TD-SCDMA standard. In this example, the UMTS system includes a (radio access network) RAN 102 (e.g., UTRAN) that provides various wireless services including telephony, video, data, messaging, broadcasts, and/or other services. The RAN 102 may be divided into a number of Radio Network Subsystems (RNSs) such as an RNS 107, each controlled by a Radio Network Controller (RNC) such as an RNC 106. For clarity, only the RNC 106 and the RNS 107 are shown; however, the RAN 102 may include any number of RNCs and RNSs in addition to the RNC 106 and RNS 107. The RNC 106 is an apparatus responsible for, among other things, assigning, reconfiguring and releasing radio resources within the RNS 107. The RNC 106 may be interconnected to other RNCs (not shown) in the RAN 102 through various types of interfaces such as a direct physical connection, a virtual network, or the like, using any suitable transport network.

The geographic region covered by the RNS 107 may be divided into a number of cells, with a radio transceiver apparatus serving each cell. A radio transceiver apparatus is commonly referred to as a node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two node Bs 108 are shown; however, the RNS 107 may include any number of wireless node Bs. The node Bs 108 provide wireless access points to a core network 104 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 110 are shown in communication with the node Bs 108. The downlink (DL), also called the forward link, refers to the communication link from a node B to a UE, and the uplink (UL), also called the reverse link, refers to the communication link from a UE to a node B.

The core network 104, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 104 supports circuit-switched services with a mobile switching center (MSC) 112 and a gateway MSC (GMSC) 114. One or more RNCs, such as the RNC 106, may be connected to the MSC 112. The MSC 112 is an apparatus that controls call setup, call routing, and UE mobility functions. The MSC 112 also includes a visitor location register (VLR) (not shown) that contains subscriber-related information for the duration that a UE is in the coverage area of the MSC 112. The GMSC 114 provides a gateway through the MSC 112 for the UE to access a circuit-switched network 116. The GMSC 114 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 114 queries the HLR to determine the UE's location and forwards the call to the particular MSC serving that location.

The core network 104 also supports packet-data services with a serving GPRS support node (SGSN) 118 and a gateway GPRS support node (GGSN) 120. GPRS, which stands for General Packet Radio Service, is designed to provide packet-data services at speeds higher than those available with standard GSM circuit-switched data services. The GGSN 120 provides a connection for the RAN 102 to a packet-based network 122. The packet-based network 122 may be the Internet, a private data network, or some other suitable packet-based network. The primary function of the GGSN 120 is to provide the UEs 110 with packet-based network connectivity. Data packets are transferred between the GGSN 120 and the UEs 110 through the SGSN 118, which performs primarily the same functions in the packet-based domain as the MSC 112 performs in the circuit-switched domain.

The UMTS air interface is a spread spectrum Direct-Sequence Code Division Multiple Access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a node B 108 and a UE 110, but divides uplink and downlink transmissions into different time slots in the carrier.

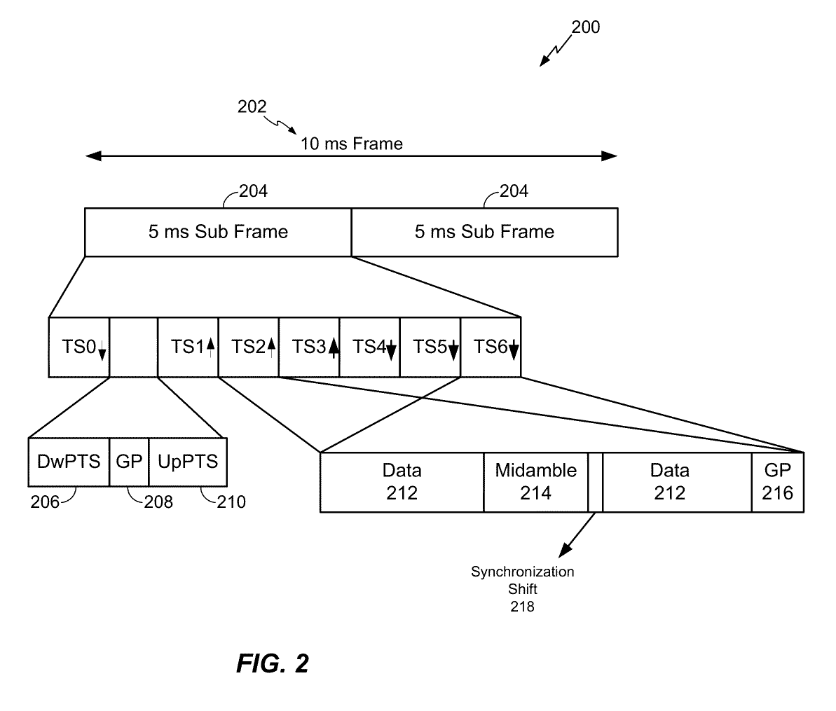

FIG. 2 shows a frame structure 200 for a TD-SCDMA carrier. The TD-SCDMA carrier, as illustrated, has a frame 202 that is 10 ms in length. The chip rate in TD-SCDMA is 1.28 Mcps. The frame 202 has two 5 ms subframes 204, and each of the subframes 204 includes seven time slots, TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 206, a guard period (GP) 208, and an uplink pilot time slot (UpPTS) 210 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 212 (each with a length of 352 chips) separated by a midamble 214 (with a length of 144 chips) and followed by a guard period (GP) 216 (with a length of 16 chips). The midamble 214 may be used for features, such as channel estimation, while the guard period 216 may be used to avoid inter-burst interference. Also transmitted in the data portion is some Layer 1 control information, including Synchronization Shift (SS) bits 218. Synchronization Shift bits 218 only appear in the second part of the data portion. The Synchronization Shift bits 218 immediately following the midamble can indicate three cases: decrease shift, increase shift, or do nothing in the upload transmit timing. The positions of the SS bits 218 are not generally used during uplink communications.

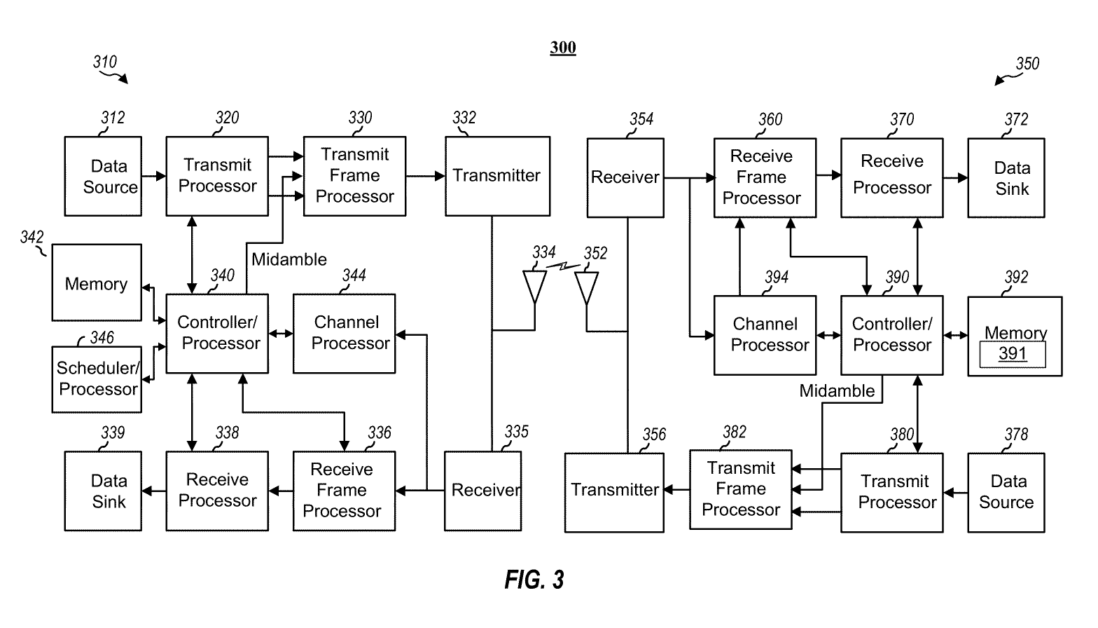

FIG. 3 is a block diagram of a node B 310 in communication with a UE 350 in a RAN 300, where the RAN 300 may be the RAN 102 in FIG. 1, the node B 310 may be the node B 108 in FIG. 1, and the UE 350 may be the UE 110 in FIG. 1. In the downlink communication, a transmit processor 320 may receive data from a data source 312 and control signals from a controller/processor 340. The transmit processor 320 provides various signal processing functions for the data and control signals, as well as reference signals (e.g., pilot signals). For example, the transmit processor 320 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 344 may be used by a controller/processor 340 to determine the coding, modulation, spreading, and/or scrambling schemes for the transmit processor 320. These channel estimates may be derived from a reference signal transmitted by the UE 350 or from feedback contained in the midamble 214 (FIG. 2) from the UE 350. The symbols generated by the transmit processor 320 are provided to a transmit frame processor 330 to create a frame structure. The transmit frame processor 330 creates this frame structure by multiplexing the symbols with a midamble 214 (FIG. 2) from the controller/processor 340, resulting in a series of frames. The frames are then provided to a transmitter 332, which provides various signal conditioning functions including amplifying, filtering, and modulating the frames onto a carrier for downlink transmission over the wireless medium through smart antennas 334. The smart antennas 334 may be implemented with beam steering bidirectional adaptive antenna arrays or other similar beam technologies.

At the UE 350, a receiver 354 receives the downlink transmission through an antenna 352 and processes the transmission to recover the information modulated onto the carrier. The information recovered by the receiver 354 is provided to a receive frame processor 360, which parses each frame, and provides the midamble 214 (FIG. 2) to a channel processor 394 and the data, control, and reference signals to a receive processor 370. The receive processor 370 then performs the inverse of the processing performed by the transmit processor 320 in the node B 310. More specifically, the receive processor 370 descrambles and despreads the symbols, and then determines the most likely signal constellation points transmitted by the node B 310 based on the modulation scheme. These soft decisions may be based on channel estimates computed by the channel processor 394. The soft decisions are then decoded and deinterleaved to recover the data, control, and reference signals. The CRC codes are then checked to determine whether the frames were successfully decoded. The data carried by the successfully decoded frames will then be provided to a data sink 372, which represents applications running in the UE 350 and/or various user interfaces (e.g., display). Control signals carried by successfully decoded frames will be provided to a controller/processor 390. When frames are unsuccessfully decoded by the receiver processor 370, the controller/processor 390 may also use an acknowledgement (ACK) and/or negative acknowledgement (NACK) protocol to support retransmission requests for those frames.

In the uplink, data from a data source 378 and control signals from the controller/processor 390 are provided to a transmit processor 380. The data source 378 may represent applications running in the UE 350 and various user interfaces (e.g., keyboard). Similar to the functionality described in connection with the downlink transmission by the node B 310, the transmit processor 380 provides various signal processing functions including CRC codes, coding and interleaving to facilitate FEC, mapping to signal constellations, spreading with OVSFs, and scrambling to produce a series of symbols. Channel estimates, derived by the channel processor 394 from a reference signal transmitted by the node B 310 or from feedback contained in the midamble transmitted by the node B 310, may be used to select the appropriate coding, modulation, spreading, and/or scrambling schemes. The symbols produced by the transmit processor 380 will be provided to a transmit frame processor 382 to create a frame structure. The transmit frame processor 382 creates this frame structure by multiplexing the symbols with a midamble 214 (FIG. 2) from the controller/processor 390, resulting in a series of frames. The frames are then provided to a transmitter 356, which provides various signal conditioning functions including amplification, filtering, and modulating the frames onto a carrier for uplink transmission over the wireless medium through the antenna 352.

The uplink transmission is processed at the node B 310 in a manner similar to that described in connection with the receiver function at the UE 350. A receiver 335 receives the uplink transmission through the antenna 334 and processes the transmission to recover the information modulated onto the carrier. The information recovered by the receiver 335 is provided to a receive frame processor 336, which parses each frame, and provides the midamble 214 (FIG. 2) to the channel processor 344 and the data, control, and reference signals to a receive processor 338. The receive processor 338 performs the inverse of the processing performed by the transmit processor 380 in the UE 350. The data and control signals carried by the successfully decoded frames may then be provided to a data sink 339 and the controller/processor, respectively. If some of the frames were unsuccessfully decoded by the receive processor, the controller/processor 340 may also use an acknowledgement (ACK) and/or negative acknowledgement (NACK) protocol to support retransmission requests for those frames.

The controller/processors 340 and 390 may be used to direct the operation at the node B 310 and the UE 350, respectively. For example, the controller/processors 340 and 390 may provide various functions including timing, peripheral interfaces, voltage regulation, power management, and other control functions. The computer readable media of memories 342 and 392 may store data and software for the node B 310 and the UE 350, respectively. For example, the memory 392 of the UE 350 may store an inter-RAT measurement module 391 which, when executed by the controller/processor 390, configures the UE 350 for inter-RAT/inter-frequency measurements. A scheduler/processor 346 at the node B 310 may be used to allocate resources to the UEs and schedule downlink and/or uplink transmissions for the UEs.

### Inter-Rat Measurements for a Dual-SIM Dual-Active Device

Typically, in TD-SCDMA systems, the TD-SCDMA network may only cover a portion of a geographical area. The remaining portions of the geographical area may be covered by another network, such as a GSM network. A handover or cell reselection may be performed when a user equipment (UE) moves from a coverage area of a TD-SCDMA cell to the coverage area of a cell of another network, such as a GSM cell, and vice versa.

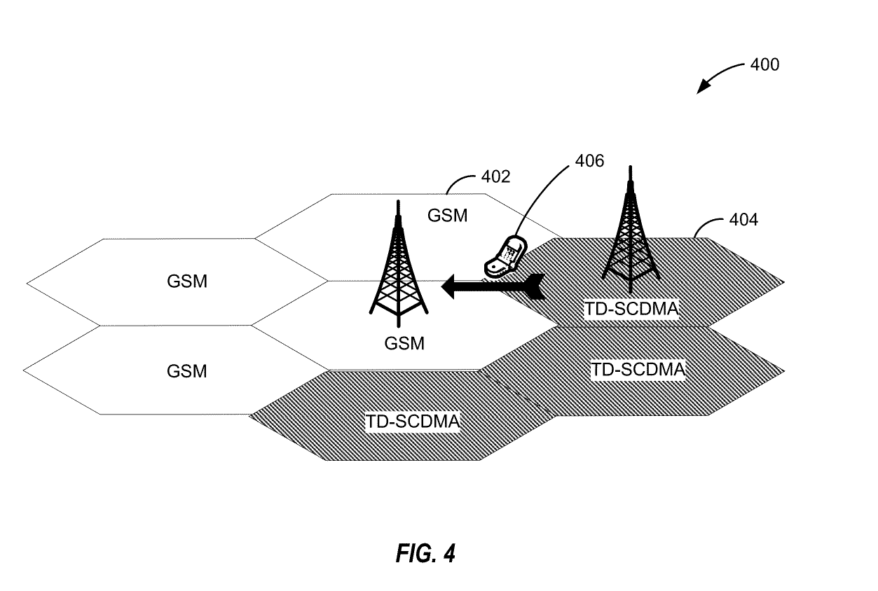

FIG. 4 illustrates the coverage of a typical TD-SCDMA network. As illustrated in FIG. 4, a geographical area 400 may include GSM cells 402 and TD-SCDMA cells 404. A UE 406 may move from one cell, such as a TD-SCDMA cell 404, to another cell, such as a GSM cell 402. The movement of the UE 406 may initiate a handover or a cell reselection.

When moving from a first network to a second network, the UE may perform measurements of the neighboring cells of the second network. The measurements may include signal strength, frequency channel, base station identity code (BSIC), and/or other measurements. After performing the measurements, the UE may connect to the strongest cell of the second network. For example, when moving from a TD-SCDMA network to a GSM network, the UE may measure the signal strength, frequency channel, and/or base station identity code of neighboring GSM cells to determine the appropriate GSM cell to associate with.

Typically, a UE associated with a TD-SCDMA cell may stay on the TD-SCDMA cell to monitor TD-SCDMA paging messages. The UE may monitor the TD-SCDMA paging messages for approximately 20 ms and may subsequently perform inter-frequency/inter-RAT GSM measurements for approximately 20-50 ms. The aforementioned monitoring and measuring is similarly performed for a GSM network. That is, a UE associated with a GSM network may monitor GSM paging messages for approximately 20 ms and perform inter-frequency/inter-RAT TD-SCDMA measurement for approximately 20-50 ms.

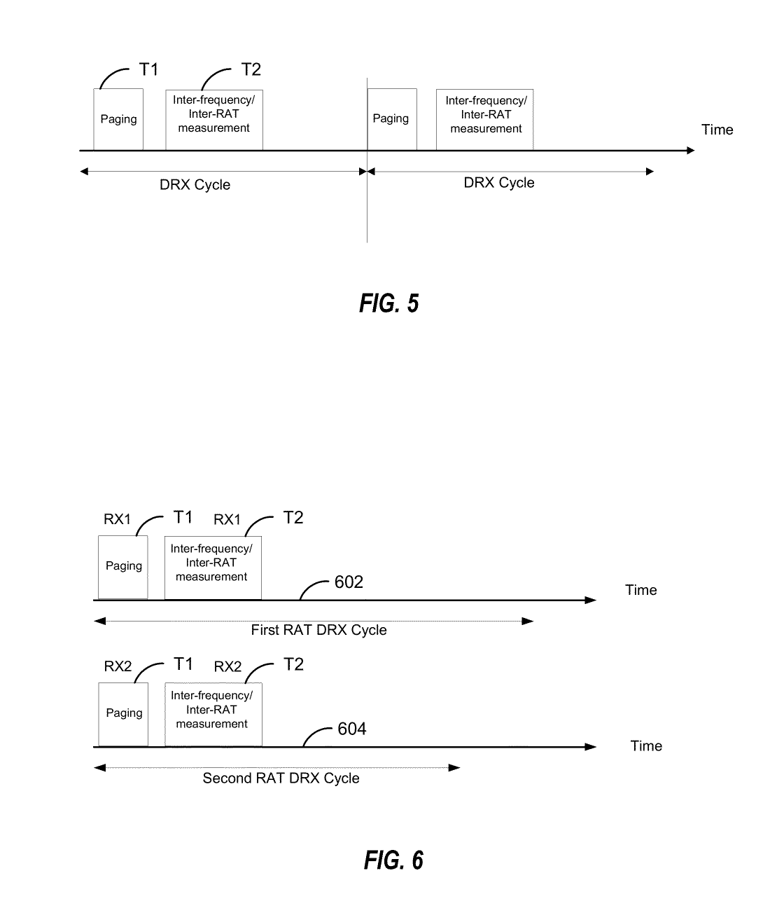

FIG. 5 illustrates an exemplary timeline for a typical UE associated with a cell network. As illustrated in FIG. 5, at time T1, the UE monitors paging messages of a first RAT. Furthermore, at time T2, the UE performs inter-frequency/inter-RAT measurements of a second RAT. In this example, the second RAT is different from the first RAT. The paging message monitoring and inter-frequency/inter-RAT measurements may be repeated at each subsequent discontinuous reception (DRX) cycle. The exemplary timeline for a typical UE shown in FIG. 5 may be undesirable because of an increased time for monitoring the paging messages and performing the inter-frequency/inter-RAT measurements of the various RATs.

In some cases, a UE may include more than one subscriber identity module (SIM)/universal subscriber identity module (USIM). A UE with more than one SIM may be referred to as a multi-SIM/multi-talk UE. In the present disclosure, a SIM may refer to a SIM or a USIM. Each SIM includes a unique International Mobile Subscriber Identity (IMSI) and service subscription information. Moreover, each SIM may be associated with a unique phone number. Thus, the UE may use each SIM to send and receive phone calls.

Furthermore, in some cases, the UE may have different baseband modules for different networks. For example, the UE may include a TD-SCDMA baseband module and a GSM baseband module. In one configuration, each baseband module is associated with a different SIM. For example, the TD-SCDMA baseband module may be associated with a first SIM and a GSM baseband module may be associated with a second SIM.

Additionally, in one configuration, the dual baseband module UE is configured for dual receive chains. In this configuration, the UE is referred to as a dual-SIM dual-standby (DSDS) UE. Still, in another configuration, the dual baseband UE is configured for dual transmit and dual receive chains. In this configuration, the UE is referred to as a dual-SIM dual-active (DSDA) UE.

In some cases, dual-SIM dual-active and/or dual-SIM dual-standby UEs may experience conflicts when monitoring paging messages and performing inter-RAT/inter-frequency measurements. That is, in some cases, when using both receive chains, the paging messages may overlap and cause a conflict. Likewise, the time for performing inter-RAT/inter-frequency measurements may overlap for each receive chain and cause a conflict. Aspects of the present disclosure provide a dual-SIM dual-active and/or dual-SIM dual-standby UE that mitigates conflicts when monitoring paging messages and improves the performance of the inter-RAT/inter-frequency measurements. In the present disclosure the term UE refers to a dual-SIM dual-active and/or dual-SIM dual-standby UE. It should be noted that according to aspects of the present disclosure, the UE includes two or more receiver chain modules.

According to one aspect of the present disclosure, the receive chains of each RAT are split and the paging messages of each RAT are simultaneously monitored. Furthermore, in this configuration, the split receive chains are used for simultaneous inter-RAT/inter-frequency measurements of each RAT. That is, a first receive chain may be used for inter-RAT/inter-frequency measurements of a first RAT for a first SIM and a second receive chain may be used for inter-RAT/inter-frequency measurements of a second RAT for a second SIM. The inter-RAT/inter-frequency measurements are performed subsequent to the monitoring of paging messages.

FIG. 6 illustrates an exemplary timeline for split receive chains according to an aspect of the present disclosure. As illustrated in FIG. 6, the receive chains RX1 and RX2 of each RAT 602 and 604 are split. At time T1, the paging messages for each RAT 602 and 604 are monitored using a specific receive chain. In one configuration, each paging message for each RAT 602 and 604 is monitored for a different SIM. As shown in FIG. 6, the paging message monitoring for a first RAT 602 may use a first receive chain RX1 and the paging message monitoring for a second RAT 604 may use a second receive chain RX2. That is, although the paging messages overlap in time, to mitigate a conflict, each paging message is monitored by a different receive chain. Furthermore, subsequent to monitoring the paging messages, at time T2, each RAT 602 and 604 performs inter-RAT/inter-frequency measurements. In this configuration, each inter-RAT/inter-frequency measurement is performed for a different SIM. In one configuration, the first RAT 602 is a TD-SCDMA RAT and the second RAT 604 is a GSM RAT.

In some cases, the monitoring of the paging messages may affect the inter-RAT/inter-frequency measurements. Thus, according to another aspect of the present disclosure, the inter-RAT/inter-frequency measurements may be delayed until all paging messages have been received. In one configuration, both receive chains are used to monitor each paging message. Furthermore, both receive chains may also be used for inter-RAT/inter-frequency measurements of a first RAT associated with the most recently monitored paging message. Finally, both receive chains may be further used for the inter-RAT/inter-frequency measurements of a second RAT subsequent to the inter-RAT/inter-frequency measurements of the first RAT.

According to another aspect of the present disclosure, both receive chains may be allocated for inter-RAT/inter-frequency measurements of a first RAT with paging message signals that are weaker in comparison to paging message signals of a second RAT. In this configuration, the inter-RAT/inter-frequency measurements of the second RAT are performed subsequent to the inter-RAT/inter-frequency measurements of the first RAT.

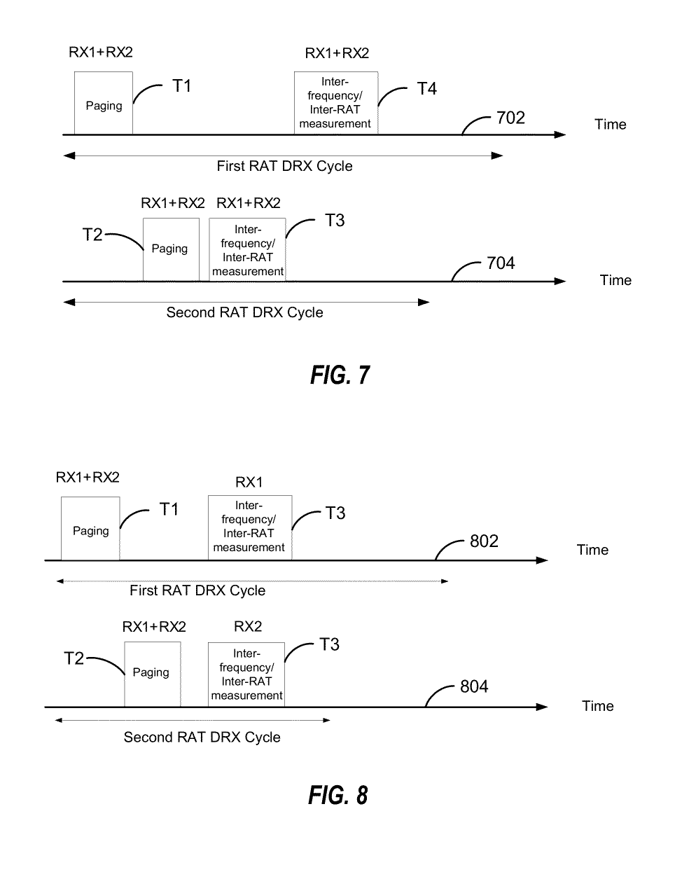

FIG. 7 illustrates an exemplary timeline for dual receive chains according to an aspect of the present disclosure. As illustrated in FIG. 7, at time T1, both receive chains RX1 and RX2 are used to monitor a paging message of a first RAT 702 for a first SIM. Furthermore, at time T2, both receive chains RX1 and RX2 are used to monitor a paging message of a second RAT 704 for a second SIM. As shown in FIG. 7, both receive chains may be used to monitor each paging message because the paging messages do not overlap in time. In the present example, because the paging message (time T2) of the second RAT 704 is the most recent paging message, at time T3, both receive chains RX1 and RX2 are used for inter-RAT/inter-frequency measurements of the second RAT 704 for the second SIM. Subsequent to the inter-RAT/inter-frequency measurements of the second RAT 704, at time T4, both receive chains RX1 and RX2 are used for the inter-RAT/inter-frequency measurement of the first RAT 702 for the first SIM. In one configuration, the first RAT 702 is a TD-SCDMA RAT and the second RAT 704 is a GSM RAT.

According to yet another aspect of the present disclosure, both receive chains may be used to monitor each paging message, however, in the present configuration the receive chains are split to simultaneously perform inter-RAT/inter-frequency measurements of each RAT.

FIG. 8 illustrates an exemplary timeline for dual receive chains according to this aspect of the present disclosure. As illustrated in FIG. 8, at time T1, both receive chains RX1 and RX2 are used to monitor a paging message of a first RAT 802 for a first SIM. Furthermore, at time T2, both receive chains RX1 and RX2 are used to monitor a paging message of a second RAT 804 for a second SIM. Finally, at time T3, subsequent to monitoring the final paging message at time T2, the receive chains RX1 and RX2 are split so that each receive chain is used for inter-RAT/inter-frequency measurements of each RAT 802 and 804. For example, a first receive chain RX1 is used for inter-RAT/inter-frequency measurements of a first RAT 802 for the first SIM and a second receive chain RX2 is used for inter-RAT/inter-frequency measurements of a second RAT 804 for the second SIM. The time for performing the inter-RAT/inter-frequency measurements may be substantially simultaneous or at an offset. In one configuration, the first RAT 802 is a TD-SCDMA RAT and the second RAT 804 is a GSM RAT.

It should be noted that aspects of the present disclosure have been presented for a UE with two receive chains. The aspects of the present disclosure may also be implemented with UEs having more than two receive chains.

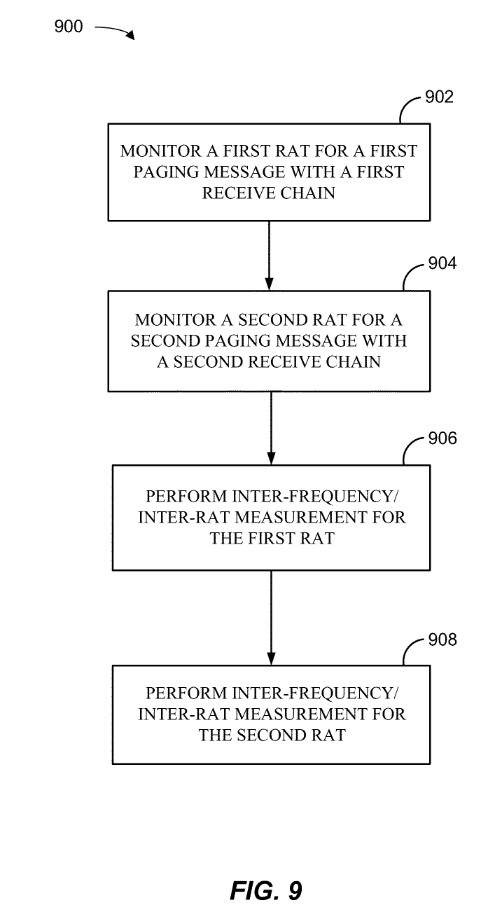

FIG. 9 shows a wireless communication method 900 according to one aspect of the disclosure. A UE monitors a first RAT for a first paging message with a first receive chain, at block 902. In one configuration, the first paging message is monitored for a first SIM. Additionally, at block 904, the UE also monitors a second RAT for a second paging message with a second receive chain. In one configuration, the second paging message is monitored for a second SIM. The UE also performs inter-frequency/inter-RAT measurement for the first RAT with the first receive chain at block 906. The inter-frequency/inter-RAT measurement for the first RAT may be performed subsequent to monitoring for the first paging message and the second paging message. Finally, at block 908, the UE performs inter-frequency/inter-RAT measurement for the second RAT with the second receive chain. The inter-frequency/inter-RAT measurement for the second RAT may be performed subsequent to monitoring for the first paging message and the second paging message.

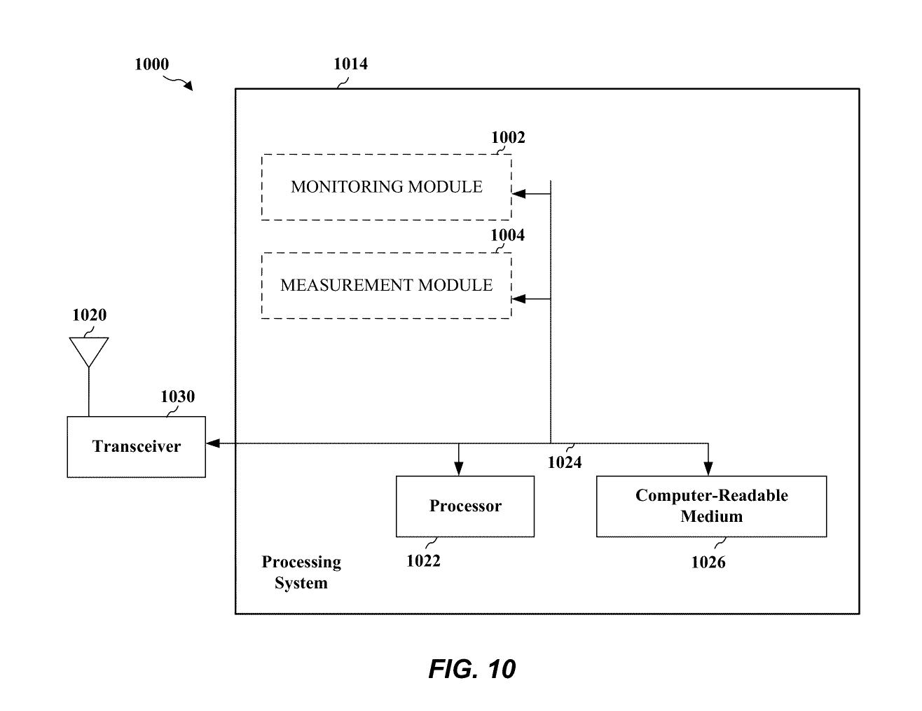

FIG. 10 is a diagram illustrating an example of a hardware implementation for an apparatus 1000 employing a processing system 1014. The processing system 1014 may be implemented with a bus architecture, represented generally by the bus 1024. The bus 1024 may include any number of interconnecting buses and bridges depending on the specific application of the processing system 1014 and the overall design constraints. The bus 1024 links together various circuits including one or more processors and/or hardware modules, represented by the processor 1022 the modules 1002, 1004 and the computer-readable medium 1026. The bus 1024 may also link various other circuits such as timing sources, peripherals, voltage regulators, and power management circuits, which are well known in the art, and therefore, will not be described any further.

The apparatus includes a processing system 1014 coupled to a transceiver 1030. The transceiver 1030 is coupled to one or more antennas 1020. The transceiver 1030 enables communicating with various other apparatus over a transmission medium. The processing system 1014 includes a processor 1022 coupled to a computer-readable medium 1026. The processor 1022 is responsible for general processing, including the execution of software stored on the computer-readable medium 1026. The software, when executed by the processor 1022, causes the processing system 1014 to perform the various functions described for any particular apparatus. The computer-readable medium 1026 may also be used for storing data that is manipulated by the processor 1022 when executing software.

In one configuration, the processing system 1014 includes a monitoring module 1002 for monitoring a first RAT for a first paging message with a first receive chain. The monitoring module 1002 may also monitor a second RAT for a second paging message with a second receive chain. The processing system 1014 includes a measurement module 1004 for performing inter-frequency/inter-RAT measurement for the first RAT. The measurement module 1004 may also perform inter-frequency/inter-RAT measurements for the second RAT. The modules may be software modules running in the processor 1022, resident/stored in the computer-readable medium 1026, one or more hardware modules coupled to the processor 1022, or some combination thereof. The processing system 1014 may be a component of the UE 350 and may include the memory 392, and/or the controller/processor 390.

In one configuration, an apparatus such as a UE is configured for wireless communication including means for monitoring and means for measuring. In one aspect, the above means may be the antennas 352, the receiver 354, the channel processor 394, the receive frame processor 360, the receive processor 370, the transmitter 356, the transmit frame processor 382, the transmit processor 380, the controller/processor 390, the memory 392, the inter-RAT measurement module 391, monitoring module 1002, measurement module 1004 and/or the processing system 1014 configured to perform the functions recited by the aforementioned means. In another aspect, the aforementioned means may be a module or any apparatus configured to perform the functions recited by the aforementioned means.

Several aspects of a telecommunications system has been presented with reference to TD-SCDMA systems. As those skilled in the art will readily appreciate, various aspects described throughout this disclosure may be extended to other telecommunication systems, network architectures and communication standards. By way of example, various aspects may be extended to other UMTS systems such as W-CDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication in a multi subscriber identity module (SIM) device, comprising:
monitoring a first RAT (radio access technology) for a first paging message with at least a first receive chain, the first paging message being monitored for a first SIM;
monitoring a second RAT for a second paging message with at least a second receive chain, the second paging message being monitored for a second SIM;
performing, for the first SIM, an inter-frequency/inter-RAT measurement for the first RAT, the inter-frequency/inter-RAT measurement being performed with at least the first receive chain after monitoring for the first paging message and the second paging message; and
performing, for the second SIM, an inter-frequency/inter-RAT measurement for the second RAT, the inter-frequency/inter-RAT measurement being performed with at least the second receive chain after monitoring for the first paging message and the second paging message.

2. The method of claim 1, in which:
monitoring for the first paging message and the second paging message occurs substantially simultaneously; and
performing the inter-frequency/inter-RAT measurements for the first RAT and the second RAT occurs substantially simultaneously.

3. The method of claim 1, further comprising:
monitoring for the first paging message with the second receive chain; and
monitoring for the second paging message with the first receive chain, in which the first paging message and the second paging message are monitored at different times.

4. The method of claim 3, further comprising:
performing the inter-frequency/inter-RAT measurement for the first RAT with the second receive chain; and
performing the inter-frequency/inter-RAT measurement for the second RAT with the first receive chain,
in which the inter-frequency/inter-RAT measurement for the first RAT and the second RAT are performed at different times.

5. The method of claim 3, in which the inter-frequency/inter-RAT measurement for the first RAT and the second RAT are performed substantially simultaneously.

6. The method of claim 1, in which the first RAT is a time division-synchronous code division multiple access (TD-SCDMA) radio and the second RAT is a global systems for mobile communications (GSM) radio.

7. An apparatus for wireless communication, comprising:
means for monitoring a first RAT (radio access technology) for a first paging message with at least a first receive chain, the first paging message being monitored for a first subscriber identity module (SIM);
means for monitoring a second RAT for a second paging message with at least a second receive chain, the second paging message being monitored for a second SIM;
means for performing, for the first SIM, an inter-frequency/inter-RAT measurement for the first RAT, the inter-frequency/inter-RAT measurement being performed with at least the first receive chain after monitoring for the first paging message and the second paging message; and
means for performing, for the second SIM, an inter-frequency/inter-RAT measurement for the second RAT, the inter-frequency/inter-RAT measurement being performed with at least the second receive chain after monitoring for the first paging message and the second paging message.

8. The apparatus of claim 7, in which:
the monitoring for the first paging message and the second paging message occurs substantially simultaneously; and
the performing of the inter-frequency/inter-RAT measurements for the first RAT and the second RAT occurs substantially simultaneously.

9. The apparatus of claim 7, in which:
the means for monitoring for the first paging message further comprises monitoring the first paging message with the second receive chain; and
the means for monitoring for the second paging message further comprises monitoring the second paging message with the first receive chain; and
in which the first paging message and the second paging message are monitored at different times.

10. The apparatus of claim 9, in which:
the means for performing inter-frequency/inter-RAT measurement for the first RAT further comprises means for performing the inter-frequency/inter-RAT measurement for the first RAT with the second receive chain; and
the means for performing inter-frequency/inter-RAT measurement for the second RAT further comprises means for performing the inter-frequency/inter-RAT measurement for the second RAT with the first receive chain further comprises; and
in which the inter-frequency/inter-RAT measurement for the first RAT and the second RAT are performed at different times.

11. The apparatus of claim 9, in which the inter-frequency/inter-RAT measurement for the first RAT and the second RAT are performed substantially simultaneously.

12. The apparatus of claim 7, in which the first RAT is a time division-synchronous code division multiple access (TD-SCDMA) radio and the second RAT is a global systems for mobile communications (GSM) radio.

13. A computer program product for wireless communication in a wireless network, comprising:
a non-transitory computer-readable medium having non-transitory program code recorded thereon, the program code comprising:
program code to monitor a first RAT (radio access technology) for a first paging message with at least a first receive chain, the first paging message being monitored for a first subscriber identity module (SIM);
program code to monitor a second RAT for a second paging message with at least a second receive chain, the second paging message being monitored for a second SIM;
program code to perform, for the first SIM, an inter-frequency/inter-RAT measurement for the first RAT, the inter-frequency/inter-RAT measurement being performed with at least the first receive chain after monitoring for the first paging message and the second paging message; and
program code to perform, for the second SIM, an inter-frequency/inter-RAT measurement for the second RAT, the inter-frequency/inter-RAT measurement being performed with at least the second receive chain after monitoring for the first paging message and the second paging message.

14. The computer program product of claim 13, in which:
the monitoring for the first paging message and the second paging message occurs substantially simultaneously; and
the performing of the inter-frequency/inter-RAT measurements for the first RAT and the second RAT occurs substantially simultaneously.

15. The computer program product of claim 13, in which:
the program code to monitor for the first paging message further comprises program code to monitor for the first paging message with the second receive chain; and
the program code to monitor for the second paging message further comprises program code to monitor for the second paging message with the first receive chain; and
in which the first paging message and the second paging message are monitored at different times.

16. The computer program product of claim 15, in which:
the program code to perform the inter-frequency/inter-RAT measurement for the first RAT further comprises program code to perform the inter-frequency/inter-RAT measurement for the first RAT with the second receive chain; and
the program code to perform the inter-frequency/inter-RAT measurement for the second RAT further comprises program code to perform the inter-frequency/inter-RAT measurement for the second RAT with the first receive chain further comprises; and
in which the inter-frequency/inter-RAT measurement for the first RAT and the second RAT are performed at different times.

17. The computer program product of claim 13, in which the first RAT is a time division-synchronous code division multiple access (TD-SCDMA) radio and the second RAT is a global systems for mobile communications (GSM) radio.

18. An apparatus for wireless communication, comprising:
a memory; and
at least one processor coupled to the memory, the at least one processor being configured:
to monitor a first RAT (radio access technology) for a first paging message with at least a first receive chain, the first paging message being monitored for a first subscriber identity module (SIM);
to monitor a second RAT for a second paging message with at least a second receive chain, the second paging message being monitored for a second SIM;
to perform, for the first SIM, an inter-frequency/inter-RAT measurement for the first RAT, the inter-frequency/inter-RAT measurement being performed with at least the first receive chain after monitoring for the first paging message and the second paging message; and
to perform, for the second SIM, an inter-frequency/inter-RAT measurement for the second RAT, the inter-frequency/inter-RAT measurement being performed with at least the second receive chain after monitoring for the first paging message and the second paging message.

19. The apparatus of claim 18, in which:
the monitoring for the first paging message and the second paging message occurs substantially simultaneously; and
the performing of the inter-frequency/inter-RAT measurements for the first RAT and the second RAT occurs substantially simultaneously.

20. The apparatus of claim 18, in which:
the at least one processor configured to monitor for the first paging message is further configured to monitor for the first paging message with the second receive chain; and
the at least one processor configured to monitor for the second paging message is further configured to monitor for the second paging message with the first receive chain; and
in which the first paging message and the second paging message are monitored at different times.

21. The apparatus of claim 20, in which:
the at least one processor configured to perform the inter-frequency/inter-RAT measurement for the first RAT is further configured to perform the inter-frequency/inter-RAT measurement for the first RAT with the second receive chain; and
the at least one processor configured to perform the inter-frequency/inter-RAT measurement for the second RAT is further configured to perform the inter-frequency/inter-RAT measurement for the second RAT with the first receive chain further comprises; and
in which the inter-frequency/inter-RAT measurement for the first RAT and the second RAT are performed at different times.

22. The apparatus of claim 18, in which the first RAT is a time division-synchronous code division multiple access (TD-SCDMA) radio and the second RAT is a global systems for mobile communications (GSM) radio.
